(19) United States
(12) Patent Application Publication
(10) Pub. No.: US 2022/0312768 A1
(43) Pub. Date: Oct. 6, 2022

(54) COMBINATIONS OF AGROCHEMICALS WITH METABOLIC INHIBITORS

(71) Applicant: THE BOARD OF TRUSTEES OF THE UNIVERSITY OF ARKANSAS, Little Rock, AR (US)

(72) Inventors: Jason Keith Norsworthy, West Fork, AR (US); Grant Lawson Priess, Springdale, AR (US)

(21) Appl. No.: 17/712,508

(22) Filed: Apr. 4, 2022

Related U.S. Application Data
(60) Provisional application No. 63/170,265, filed on Apr. 2, 2021.
(60) Provisional application No. 63/188,837, filed on May 14, 2021.

(51) Int. Cl. A01N 57/20; A01N 31/08; A01N 43/08

(52) U.S. Cl. CPC A01N 57/20; A01N 31/08; A01N 43/08

(57) ABSTRACT

Disclosed herein are combinations comprising an agrochemical and a metabolic inhibitor. Also disclosed are methods of improving the efficacy of an agrochemical by using it in combination with a metabolic inhibitor. Further disclosed are methods for controlling a grass or a broadleaf weed in a crop using the combinations disclosed herein.

### CROSS-REFERENCE TO RELATED APPLICATIONS

This application claims benefit of priority to U.S. patent application Ser. No. 63/170,265, filed Apr. 2, 2021, and U.S. patent application Ser. No. 63/188,837, filed May 14, 2021, the contents of each are incorporated by reference in their entirety.

### FIELD OF THE INVENTION

Described herein are combinations of agrochemicals and metabolic inhibitors. Also described are methods of improving the efficacy of agrochemicals by using them in combination with metabolic inhibitors, and methods for controlling grasses or broadleaf weeds using an agrochemical and metabolic inhibitor.

### BACKGROUND OF THE INVENTION

Glufosinate (phosphinothricin (2-amino-4-hydroxy(methyl)phosphinoyl]butanoic acid), along with its salts and isomers, is one of the most important herbicides in the agrochemical industry. Glufosinate is a nonselective, postemergence herbicide that controls broadleaf and grass weed species.

The efficacy of glufosinate is dependent on environmental conditions at application, such as light intensity, soil moisture, size of spray droplets, and humidity. Subpar weed control often results when these application parameters are not ideal, leaving the grower with a distaste for the herbicide.

Palmer amaranth (Amaranthus palmeri) and waterhemp (Amaranthus tuberculatus) are two of the most important weeds in U.S. agronomic cropping systems. In 2022, glufosinate-resistant Palmer amaranth was confirmed in Arkansas. This is the first case of glufosinate-resistance occurring in a broadleaf weed species globally (Priess et al. 2022 in-press). Additional weeds are expected to acquire resistance to glufosinate, its salts, and its isomers through enhanced herbicide metabolism. Weed species such as Chenopodium album, Digitaria purpurea, Galium vernum, Ipomoea purpurea, Lythrum hyssopifolia, Digitaria purpurea, and Amaranthus palmeri have all shown some degree of glufosinate metabolism. When resistance to glufosinate does evolve, one of the last effective means of chemical control for weeds like Amaranthus palmeri will become ineffective.

Thus, there is a need in the art for a means to improve the efficacy of glufosinate, and its salts and isomers, under a range of environmental conditions and to increase the sustainable lifetime of these herbicides.

### SUMMARY OF THE INVENTION

In a first aspect, the present invention provides combinations comprising an agrochemical and a metabolic inhibitor. In some embodiments, the agrochemical is glufosinate, or a salt or an isomer thereof. In some embodiments, the metabolic inhibitor is a glutathione S-transferase inhibitor, a glyoxylate pathway inhibitor, a cytochrome P450 inhibitor, or a reactive oxygen species (ROS) inducer. In some embodiments, the metabolic inhibitor is a polyphenol.

In a second aspect, the present invention provides methods of improving the efficacy of an agrochemical. The methods comprise using the agrochemical in the presence of a metabolic inhibitor.

In a third aspect, the present invention provides methods for controlling grasses or broadleaf weeds. The methods comprise applying an agrochemical and a metabolic inhibitor to a field having the weeds. Suitably, the effective amount of the agrochemical is less than the amount otherwise required for the same weed control in the absence of the metabolic inhibitor under a particular set of environmental conditions.

### BRIEF DESCRIPTION OF THE DRAWINGS

FIG. 1 shows photographs of the results of a field trial experiment taken at 30 days after application. The metabolic inhibitor 4-chloro-7-nitrobenzofurazan (NBD-CL) was mixed with glufosinate at a rate of 6.81 grams active ingredient per acre (g ai A⁻¹) and applied to a field at 10 pm under dark conditions (right panel). The results are compared to a field treated with glufosinate alone applied at the labeled rate to larger than labeled weeds at 10 am (middle panel) and to a non-treated field (left panel).

FIG. 2 shows photographs of the results of the same field experiment described in FIG. 1 taken at 30 days after application. Again, NBD-CL was mixed with glufosinate at a rate of 6.81 g ai A⁻' and applied at 10 pm (right panel). The results are compared to a field treated with glufosinate alone applied at the labeled rate at 10 pm (middle panel) and to a nontreated field (left panel).

FIG. 3 shows a graph of the results of the field experiment described in FIGS. 1-2. The percent control of Palmer amaranth is shown for fields treated with glufosinate alone applied at the labeled rate at 10 am and 10 pm, and for fields treated with a combination of glufosinate and NBD-CL at two rates (6.81 g ai A⁻¹ and 109 g ai A⁻¹) at 10 pm.

FIG. 4 shows a graph of Palmer amaranth control 7 days after application (DAA) of the indicated metabolic inhibitor-glufosinate combinations.

FIG. 5 shows a graph of Palmer amaranth control 14 days after application (DAA) of the indicated metabolic inhibitor-glufosinate combinations.

FIG. 6 shows Palmer amaranth percent biomass reduction relative to the untreated control of the indicated metabolic inhibitor-glufosinate combinations.

### DETAILED DESCRIPTION OF THE INVENTION

Disclosed herein are compositions and methods for the control of grasses and broadleaf weeds in crops. As demonstrated in the Examples, the combination of a metabolic inhibitor with glufosinate, or a salt or an isomer thereof, increases the ability to control Palmer amaranth. Thus, a first advantage of the present invention is that it increases the efficacy of these herbicides. Moreover, the inventors demonstrated that a combination of glufosinate, or a salt or an isomer thereof, and metabolic inhibitor reduces application limitations, allowing these herbicides to be applied, for example, under low-light conditions, to large grasses or weeds, or at amounts lower than recommended in the art. Thus, a second advantage of the present invention is that it allows for more consistent weed control with glufosinate herbicides by making them less dependent on environmental conditions.

### Compositions:

In a first aspect, the present invention provides combinations comprising an agrochemical and a metabolic inhibitor. The combinations preferably comprise an effective amount of an agrochemical and an effective amount of a metabolic inhibitor to control grass or broadleaf weeds in a crop.

As used herein, the term “agrochemical” refers to a chemical product used in agriculture. Suitable agrochemicals for use with the present invention include, without limitation, insecticides, herbicides, fungicides, nematicides, synthetic fertilizers, hormones and other chemical growth agents, and concentrated stores of raw animal manure. An effective amount of an agrochemical is an amount that provides for the desired effect for which the agrochemical is being used alone or in combination with a metabolic inhibitor. In some embodiments, an effective amount of an agrochemical is an amount that provides for the desired effect for which the agrochemical is being used in combination with a metabolic inhibitor but that fails to provide for the desired effect in the absence of the metabolic inhibitor.

In an embodiment, the agrochemical is an herbicide. An effective amount of an herbicide is an amount capable of controlling one or more grass or broadleaf weeds in a crop alone or in combination with a metabolic inhibitor. In some embodiments, an effective amount of an agrochemical is an amount that controls one or more grass or broadleaf weeds in a crop in combination with a metabolic inhibitor disclosed herein but that fails to control the grass or broadleaf weed in the absence of the metabolic inhibitor.

In some embodiments, the agrochemical comprises glufosinate or a salt, ester, or isomer thereof. Glufosinate, 2-amino-4-[hydroxy(methyl)phosphoryl]butanoic acid, is a non-proteinogenic alpha-amino acid that is a 2-aminobutanoic acid which is substituted at position 4 by a hydroxy(methyl)phosphoryl group. Glufosinate, and its salts and isomers, irreversibly inhibit glutamine synthetase, an enzyme necessary for the production of glutamine. Glutamine is an amino acid that is needed in many downstream pathways for plant growth and photosynthesis. The application of these herbicides leads to reduced glutamine levels, a break in the glyoxylate pathway, and accumulation of substrates that interact negatively with rubisco which halts photosynthesis and results in plant death (Weed Science 48:160-170, 2000).

In some embodiments, the agrochemical is an isomer of glufosinate. The term “isomer” is used to describe molecules with an identical molecular formula but with a distinct special arrangement of atoms. As used herein, an isomer comprises at least 70 mol % of the desired isomer in relative to all of the isomers having an identical molecular formula. In some embodiments, an isomer comprises at least 80 mol %, 90 mol %, 95 mol %, 98 mol %, 99 mol %, or is an enantiomerically pure isomer. In one embodiment, the agrochemical is L-glufosinate, (25)-2-amino-4-[hydroxy(methyl)phosphinoyl]butyric acid. An isomer of L-glufosinate comprises at least 70 mol % L-glufosinate. In some embodiments, L-glufosinate comprises at least 80 mol %, 90 mol %, 95 mol %, 98 mol %, 99 mol %, or is enantiomerically pure L-glufosinate. The L-isomer of glufosinate is the active herbicide. Use of L-glufosinate allows for lower product per acre than the racemic mixture, reduces shipping costs, and makes handling the agrochemical easier.

In some embodiments, the agrochemical is a salt of glufosinate. Suitable salts of glufosinate for use with the present invention include, without limitation, monosodium salts, disodium salts, monopotassium salts, dipotassium salts, calcium salts, ammonium salts, NH₃(CH₃)⁺, —NH₂(CH₃)2⁺, NH(CH₃)₃⁺, NH(CH₃)₂(C₂H₄OH)⁺, and NH₂(CH₃)(C₂H₄OH)⁺ salts of glufosinate. Examples include ammonium 2-amino-4-(methylphosphinato)butyric acid, sodium 2-amino-4-(methylphosphinato)butyric acid, and potassium 2-amino-4-(methylphosphinato)butyric acid, ammonium (2S)-2-amino-4-(methylphosphinato)butyric acid, sodium (2S)-2-amino-4-(methylphosphinato)butyric acid, and potassium (2S)-2-amino-4-(methylphosphinato)butyric acid.

In Example 2, the inventors demonstrated that the efficacy of a composition identified as KFD-581-01, which comprises an ammonium salt of at least 91 mol % L-isomer of glufosinate, is improved by administration in combination with a metabolic inhibitor. Thus, in some embodiments, the agrochemical is a salt of L-glufosinate. In specific embodiments, the agrochemical is KFD-581-01.

As used herein, a “metabolic inhibitor” is any molecule or substance that inhibits a metabolic pathway that is responsible for metabolizing the agrochemical in a plant cell. By inhibiting such pathways, metabolic inhibitors overcome the tolerance that a plant has developed against a particular agrochemical. Metabolic inhibitors may include both peptidomimetic and synthetic inhibitors. An effective amount of a metabolic inhibitor is an amount that, when used with an effective amount of an agrochemical, allows for or improves the efficacy of the agrochemical as compared to the same amount of the agrochemical alone. In embodiments where the agrochemical is an herbicide, an effective amount of the metabolic inhibitor improves the control of one or more grass or broadleaf weeds as compared to the same amount of the agrochemical alone administered under the same conditions.

In some embodiments, an improvement in efficacy is an improvement in the desired effect for the effective amount of the agrochemical in combination with the metabolic inhibitor as compared to the same amount of agrochemical alone. The improvement may be at least 10%, 20%, 30%, 40%, 50%, 60%, 70%, 80%, 90%, or 100% or between 10-200%, 20-200%, 30-200% 40-200%, 50-200%, 60-200%, 70-200%, 80-200%, 90-200%, or 100-200%.

In some embodiments, an improvement in efficacy is a reduction in the effective amount of the agrochemical needed in combination with the metabolic inhibitor to achieve the desired effect as compared to the same amount of agrochemical alone. The reduction may be at least 10%, 20%, 30%, 40%, or 50% or between 10-90%, 20-90%, 30-90% 40-90% or 50-90%.

In still further embodiments, the improvement in efficacy is an improvement in the environmental conditions under which the agrochemical can be administered. The agrochemical alone may need to be applied under particular environmental conditions to achieve suitable results. Such conditions may include light intensity (application during daylight hours), humidity, wind, and other environmental conditions. The improvement when the agrochemical is combined with the metabolic inhibitor may allow for application of the combination under less restrictive environmental conditions. In one embodiment the agrochemical alone must be applied during daylight hours if applied alone but can be applied at any time of day when applied in combination with the metabolic inhibitor.

In still further embodiments, the improvement in efficacy is an increase in the timing of administration of the agrochemical to a field based on the size or emergence of weeds in a field. The agrochemical may be approved for use on fields based on the size or emergence of grasses and broadleaf weeds in a field for achieving effective control of the grasses or broadleaf weeds. For example, the use of the agrochemical alone may be recommended on grasses and broadleaf weeds when they are less than 3 inches, less than 2 inches, less than 1 inch tall. The agrochemical in combination with the metabolic inhibitor can provide adequate control of larger or more mature grasses and broadleaf weeds than the agrochemical alone. For example, the combination of agrochemical and metabolic inhibitors may be recommended for use with grasses or broadleaf weeds that are larger than for the agrochemical alone, such as for weeds larger than 3 inches and up to 40 inches tall. In the Examples, the combination was shown to be effective at controlling weeds when applied to weeds at 4 inches, 5 inches, and up to 40 inches tall.

Suitable metabolic inhibitors for use with the present invention include, but are not limited to, those that function by inhibiting glutathione-S-transferase (GST), inhibiting the glyoxylate pathway, inhibiting a cytochrome P450, or inducing reactive oxygen species (ROS). Exemplary metabolic inhibitors include 4-chloro-7-nitrobenzofurazan (NBD-CL), curcumin, baicalin, baicalein, ellagic acid, quercetin, morin, butein,2-hydroxyl chalcone, tannic acid, quercetin, diethyl malate, malathion (diethyl 2-[(dimethoxyphosphorothioyl)sulfanyl]butanedioate), chlopyrifos (O,O-Diethyl O-3,5,6-trichloropyridin-2-yl phosphorothioate), ethacrynic acid, phloridzin, isofuranonapthoquinone, sesquiterpene lactone, gossypol, 6-(7-nitro-2,1,3-benzoxadiazol-4-ylthio)hexanol, piriprost, catechin, resveratrol, hesperidin, coniferyl ferulate, 1-chloro-2,4-dinitrobenzene (CDNB), kaemferol, genistein, and γ-glutamyl-S-(benzyl)-cysteinyl-R(−)-phenylglycine diethyl ester (TLK199, ezatiostat, Telintra®).

In some embodiments, the metabolic inhibitor is a glutathione-S-transferase inhibitor. A “glutathione-S-transferase (GST) inhibitor” is a compound or substance that inhibits the enzyme glutathione-S-transferase (GST). GST inhibitors act by binding to either the “G” binding site or the “H” binding site of glutathione S transferase enzyme. Suitably, the GST inhibitor inhibits GST activity by at least 10%, 20%, 30%, 40%, 50%, 60%, 70%, 80%, 90%, or 99%. GST activity may be detected, for example, by measuring conjugated product formation of substrates such as reduced glutathione (GSH) and 1-chloro-2,4-dinitrobenzene (CDNB) using a spectrophotometer. GST activity may be detected using a commercially available assay, such as the luminescent-based GSH/GSSG-GloT™ Assay from Promega, or the fluorescent-based Glutathione S-Transferase Fluorescent Activity Kit from Invitrogen. Suitable GST inhibitors for use with the present invention include, without limitation, 4-chloro-7-nitrobenzofurazan (NBD-CL), ellagic acid, cucurmin, quercetin, baicalin, diethyl maleate, malathion, and chlorpyrifos.

In some embodiments, the metabolic inhibitor is a glyoxylate pathway inhibitor. A “glyoxylate pathway inhibitor” is a compound or substance that inhibits the glyoxylate pathway. The glyoxylate pathway (also known as the glyoxylate cycle) is an anabolic pathway that converts acetyl-CoA to succinate for the synthesis of carbohydrates and plays a central role in the metabolism of pathogens. The glyoxylate pathway utilizes two key enzymes: malate synthase (MS) and isocitrate lyase (ICL), and most reported inhibitors of the glyoxylate pathway target the first enzyme of the pathway (i.e., ICL). However, the glyoxylate pathway inhibitor may target any enzyme involved in this pathway, including MS, ICL, citrate synthase, aconitase, succinate dehydrogenase, fumarase, and malate dehydrogenase. Suitably, the glyoxylate pathway inhibitor may inhibit an enzyme used in the glyoxylate pathway by at least 10%, 20%, 30%, 40%, 50%, 60%, 70%, 80%, 90%, or 99%. Enzyme inhibition may be measured using conventional enzyme assays, such as assays that measure the formation of an enzymatic reaction product. For example, in the case of ICL, the formation of the product NADH may be measured using a colorimetric readout. ICL activity may also be detected using a commercially available assay, such as the Isocitrate Lyase Microplate Assay Kit from Cohesion Biosciences. Suitable glyoxylate pathway inhibitors include, without limitation, caffeic acid and cinnamic acid.

In some embodiments, the metabolic inhibitor is a cytochrome P450 inhibitor. A “cytochrome P450 inhibitor” is a compound or substance that inhibits a cytochrome P450. Cytochrome P450 enzymes are a superfamily of heme-containing monooxygenases that play a central role in the detoxification of xenobiotics, such as drugs. In addition, these enzymes are involved in the biosynthesis of secondary metabolites, antioxidants, and phytohormones. Suitably, the cytochrome P450 inhibitor may inhibit a cytochrome P450 enzyme by at least 10%, 20%, 30%, 40%, 50%, 60%, 70%, 80%, 90%, or 99%. Inhibition of a cytochrome P450 can be measured as a decrease in the formation of that enzyme's metabolites. Cytochrome P450 inhibition may be detected using a commercially available assay, such as the Cytochrome P450 (CYP) inhibition assay (IC₅₀) from Cyprotex or the P450-Glo™ CYP3A4 Assay from Promega. Suitable cytochrome P450 inhibitors include, without limitation, amiodarone, amitrole, clarithromycin (Biaxin), clotrimazole, diltiazem (Cardizem), erythromycin, fluoxetine (Prozac), grapefruit juice, ketoconazole, malathion, metronidazole (Flagyl), mibefradil, nicardipine, paroxetine (Paxil), piperonyl butoxide, telithromycin (Ketek), terbinafine (Lamisil), and verapamil.

In some embodiments, the metabolic inhibitor is a reactive oxygen species (ROS) inducer. A “ROS inducer” is a compound or substance that induces the formation of ROS. ROS are unstable molecules that contain oxygen and that easily react with other molecules. They are formed during oxidative metabolism and stress responses due to the electron acceptability of oxygen. Examples of ROS include peroxides, superoxide, hydroxyl radical, singlet oxygen, and alpha-oxygen. ROS inducers promote increased ROS production, which can result in significant damage to cell structures, DNA, RNA, proteins, and the like. Suitable ROS inducers include, without limitation, saflufenacil (N′-{2-Chloro-4-fluoro-5-[1,2,3,6-tetrahydro-3-methyl-2,6-dioxo-4-(trifluoromethyl)pyrimidin-1-yl]benzoyl}-N-isopropyl-30 N-methylsulfamide), metribuzin (4-Amino-6-tert-butyl-3 -methylsulfanyl-1,2,4-triazin-5-one), paraquat (1,1′-Dimethyl-4,4′-bipyridinium dichloride), and bentazon (3-Isopropyl-1H-2,1,3-benzothiadiazin-4(3H)-one 2,2-dioxide).

In some embodiments, the metabolic inhibitor is a polyphenol. “Polyphenols” are a family of organic compounds that are found abundantly in plants and are characterized as containing multiple phenol rings. Polyphenols include flavonoids (e.g., flavones, flavonols, flavanols, flavanones, isoflavones, proanthocyanidins, flavoninoid alkaloids, and anthocyanins), phenolic acids, and lignans. Polyphenols may inhibit the metabolism of glufosinate via one or more different mechanisms. For example, some polyphenols inhibit GST, the glyoxylate pathway, or a cytochrome P450. Notably, this group of inhibitors includes several that are considered safe for human consumption such as, curcumin, baicalin, tannic acid, ellagic acid, caffeic acid, and quercetin.

In one embodiment, exemplified by Example 1, the agrochemical is glufosinate and the metabolic inhibitor is 4-chloro-7-nitrobenzofurazan (NBD-CL). In another embodiment, exemplified by Example 2, the agrochemical is KFD-581-01 and the metabolic inhibitor is curcumin, baicalin, ellagic acid, quercetin, or caffeic acid.

In some embodiments, two or more different metabolic inhibitors are used in the compositions and methods disclosed herein. When two or more different metabolic inhibitors are used, the metabolic inhibitors may function by the same or different mechanisms.

The combinations of the present invention may be formulated as a wet or dry preparation, including as a solution, emulsion, concentrate, suspension, dust, powder, paste, or granule. The formulation of the combination should be selected in view of its intended purpose. In each case, the formulation should be prepared to ensure a fine and even distribution of the agrochemical.

The combinations comprising an agrochemical and a metabolic inhibitor described herein may further comprise other additives. The additives may be used to enhance the activity of the composition or to modify its physical properties.

In some embodiments, the combinations further comprise one or more adjuvants. As used herein, as “adjuvant” is any substance included in an agrochemical formulation or added to the spray tank to improve agrochemical activity or application characteristics. Suitable adjuvants include, without limitation, a wetting agent, penetrant, spreader, carrier, dispersant, solvent, co-solvent, deposit builder, stabilizing agent, preservative, emulsifier, anti-foaming agent, anti-freezing agent, buffering agent, compatibility agent, drift control agent, fertilizer, colorant, binder, gelling agent, and the like.

In some embodiments, the adjuvant comprises a surfactant. Surfactants reduce the surface tension of water molecules, enabling each water droplet to cover a greater leaf surface area. As a result, surfactants enhance agrochemical performance by increasing surface contact, reducing runoff, and increasing leaf penetration, and may function as a spreader, deposit builder, emulsifier, wetting agent, or the like. The surfactant may be nonionic (i.e., not molecularly charged), anionic (i.e., negatively charged), cationic (i.e., positively charged), or amphoteric (i.e., both positivity and negatively charged). Suitable nonionic surfactants may comprise one or more of dimethylpolysiloxanes, alkanolamides, free fatty acids, and alkyl aryl polyoxylkane ethers.

In some embodiments, the adjuvant comprises a crop oil. “Crop oils” are petroleum-based oils that are used to increase the efficacy of agrochemicals. Crop oils may slow the drying of an agrochemical droplet on the leaf surface, increase agrochemical absorption, improve penetration, and the like. Suitable crop oils include, without limitation, methylated seed oil and vegetable oil. In some embodiments, the crop oil is provided as a crop oil concentrate, i.e., a mixture of a crop oil and a surfactant emulsifier.

### Methods for Improving the Efficacy of an Agrochemical:

In the Examples, the inventors demonstrate that the addition of a metabolic inhibitor (i.e., NBD-CL, curcumin, baicalin, ellagic acid, quercetin, or caffeic acid) to an agrochemical (i.e., glufosinate or a salt of an isomer thereof) improved the efficacy of the agrochemical (i.e., its ability to control the weed Palmer amaranth). Thus, in a second aspect, the present invention provides methods of improving the efficacy of an agrochemical. The methods comprise using the agrochemical in the presence of a metabolic inhibitor.

### Methods for Controlling Weeds

In a third aspect, the present invention provides methods for controlling grasses or broadleaf weeds. The methods comprise applying an agrochemical and a metabolic inhibitor to a field having the grasses or weeds. The agrochemical and metabolic inhibitor may be applied either as a combined formulation (e.g., as a combination disclosed herein) or as separate formulations. The methods encompass inhibiting the growth or proliferation of a grass or weed or killing the grass or weed. In some embodiments, the methods are used to control grasses or broadleaf weeds in a crop and the methods comprise applying the agrochemical and metabolic inhibitor to a field comprising the crop. One skilled in the art will appreciate that application rates of the agrochemical and metabolic inhibitor may need to be adjusted based on several factors such as the crop being grown, the weed being treated, the metabolic inhibitor being used, and the environmental conditions.

As used herein, “weed control” refers to any observable measure of control of plant growth. Weed control may comprise killing a plant, inhibiting the growth, reproduction and/or proliferation of a plant, removing or destroying a plant, and/or diminishing the activity of a plant. Weed control can be measured via visual assessment of plant mortality and/or growth reduction and is often presented as a percentage relative to untreated plants. For instance, weed control may be measured in terms of mean plant weight reduction or the percentage of plants that fail to emerge following a preemergence herbicide application. In the Examples, weed control was visually rated based on plant growth reduction, necrosis, or plant death on a 0 to 100% scale relative to the nontreated plants, with 0% representing no reduction in weed growth and 100% representing complete weed death.

In some embodiments, the methods achieve a commercially acceptable rate of weed control. The commercially acceptable rate of weed control varies with the weed species, degree of infestation, environmental conditions, and the associated crop plant. Typically, commercially effective weed control is defined as the destruction or inhibition of at least about 60%, 65%, 70%, 75%, 80%, 85%, or 90% of the weed plants. Although it is generally preferable from a commercial viewpoint that at least 70-80% of the weeds are destroyed or inhibited, commercially acceptable weed control can occur at much lower levels of destruction or inhibition, particularly with very noxious, herbicide-resistant weeds.

In some embodiments, weed control is achieved in conjunction with a commercially acceptable amount of injury to the crop. A “commercially acceptable amount of injury” is an amount of injury that does not result in a significant yield loss (i.e., an amount that leaves some or all the crop available for the crop's intended use). Crop injury may be measured by evaluating wilting, stunting, yellowing, plant tissue deformation, or plant tissue death. The commercially acceptable amount of injury varies with the crop species, degree of infestation, environmental conditions, and the weed infesting the crop. Typically, a commercially acceptable amount of injury is less than about 25%, 20%, 15%, 10%, or 5%. In certain embodiments, the amount of crop injury incurred by the use of both the agrochemical and metabolic inhibitor is no more than 50%, 40%, 30%, 20%, or 10% greater than the crop injury incurred by the use of the same amount of the agrochemical alone.

Any weed that is controlled by an agrochemical may be targeted using the methods of the present invention. For example, glufosinate, and its salts and isomers, are used to control a wide range of broadleaf and grass weed species including, without limitation, broadleaf, monocot, and Cyperus species. Exemplary weed species include Palmer amaranth (Amaranthus palmeri), waterhemp (Amaranthus tuberculatus), Lolium spp. and other grasses, Conyza spp. Malvaceae, morning glories, hemp sesbania (Sesbania bispinosa), Pennsylvania smartweed (Polygonum pensylvanicum), and yellownutsedge.

In one embodiment, the agrochemical glufosinate and the metabolic inhibitor 4-chloro-7-nitrobenzofurazan (NBD-CL) are used to control weeds.

In another embodiment, the agrochemical glufosinate and the metabolic inhibitor baicalin are used to control weeds.

In another embodiment, the agrochemical 1-glufosinate and the metabolic inhibitor 4-chloro-7-nitrobenzofurazan (NBD-CL) are used to control weeds. In another embodiment, the agrochemical 1-glufosinate and the metabolic inhibitor baicalin are used to control weeds.

In another embodiment, the agrochemical 1-glufosinate and the metabolic inhibitor curcumin are used to control weeds.

In another embodiment, the agrochemical 1-glufosinate and the metabolic inhibitor ellagic acid are used to control weeds.

In another embodiment, the agrochemical 1-glufosinate and the metabolic inhibitor quercetin are used to control weeds.

In another embodiment, the agrochemical 1-glufosinate and the metabolic inhibitor caffeic acid are used to control weeds. In another embodiment, the agrochemical 1-glufosinate and the metabolic inhibitor 4-chloro-7-nitrobenzofurazan (NBD-CL) are used to control weeds, and the NBD-CL is used at an application rate of 10 g ai/ha to 80 g ai/ha.

In another embodiment, the agrochemical 1-glufosinate and the metabolic inhibitor 4-chloro-7-nitrobenzofurazan (NBD-CL) are used to control weeds, and the NBD-CL is used at an application rate of 10 g ai/ha to 40 g ai/ha.

In another embodiment, the agrochemical 1-glufosinate and the metabolic inhibitor baicalin are used to control weeds, and the baicalin is used at an application rate of 10 g ai/ha to 80 g ai/ha.

In another embodiment, the agrochemical 1-glufosinate and the metabolic inhibitor baicalin are used to control weeds, and the baicalin is used at an application rate of 30 g ai/ha to 80 g ai/ha.

In another embodiment, the agrochemical 1-glufosinate and the metabolic inhibitor curcumin are used to control weeds, and the curcumin is used at an application rate of 10 g ai/ha to 80 g ai/ha.

In another embodiment, the agrochemical 1-glufosinate and the metabolic inhibitor curcumin are used to control weeds, and the curcumin is used at an application rate of 30 g ai/ha to 80 g ai/ha.

In another embodiment, the agrochemical 1-glufosinate and the metabolic inhibitor ellagic acid are used to control weeds, and the ellagic acid is used at an application rate of 10 g ai/ha to 80 g ai/ha.

In another embodiment, the agrochemical 1-glufosinate and the metabolic inhibitor ellagic acid are used to control weeds, and the ellagic acid is used at an application rate of 30 g ai/ha to 80 g ai/ha.

In another embodiment, the agrochemical 1-glufosinate and the metabolic inhibitor quercetin are used to control weeds, and the quercetin is used at an application rate of 10 g ai/ha to 80 g ai/ha.

In another embodiment, the agrochemical 1-glufosinate and the metabolic inhibitor caffeic acid are used to control weeds, and the caffeic acid is used at an application rate of 10 g ai/ha to 80 g ai/ha.

In another embodiment, the agrochemical 1-glufosinate and the metabolic inhibitor caffeic acid are used to control weeds, and the caffeic acid is used at an application rate of 10 g ai/ha to 40 g ai/ha.

In another embodiment, exemplified by Example 1, the agrochemical glufosinate and the metabolic inhibitor 4-chloro-7-nitrobenzofurazan (NBD-CL) are used to control Palmer amaranth. In another embodiment, exemplified by Example 2, the agrochemical KFD-581-01 and the metabolic inhibitor curcumin, baicalin, ellagic acid, quercetin, or caffeic acid are used to control Palmer amaranth.

The methods of the present invention may be used to control grasses or broadleaf weeds in any crop that can tolerate the agrochemical at the applied rate or to control weeds in an unplanted or yet to be planted field. For example, in embodiments in which the agrochemical is glufosinate, or a salt or isomer thereof, the methods can be used with canola, corn, cotton, rice, soybean, sugar beet, root and tuber vegetables, leafy vegetables, brassica leafy vegetables, small grains (e.g., barley, buckwheat, oats, rye, teosinte, triticale, and wheat), and berries or other fruit plants. In some embodiments, the treated crop is resistant to glufosinate and salt and isomers thereof. Many crops that are resistant to these herbicides were created via genetic engineering. Thus, in some embodiments, the treated crop is transgenic or is genetically modified to be resistant to these herbicides. As used herein, the term “transgenic” describes an organism or cell that contains genetic material that has been artificially introduced. Treated plants may range in age, and the age at which the agrochemical is most effective will depend on the plant being treated.

Any suitable method of application may be used to apply the agrochemical and metabolic inhibitor to the field. Agrochemicals can be applied by a variety of means including, without limitation, boom sprayers, aerial spraying, drone application, misters, blanket wipers, rope wick applicators, weed seekers, chemigation, impregnation on fertilizer, coating on fertilizer, precision application, and back-pack sprayers. For example, glufosinate, and its salts and isomers, may be used for over-the-top applications, as a foliar spray for control of emerged weeds, or in broadcast burndown applications prior to planting or crop emergence in labeled row crops. Glufosinate, and its salts and isomers, may be applied in the media, irrigation water, or hydroponic solutions used to propagate plants, or can be applied directly to the foliage of plants being grown in soil or in other media in a field, greenhouse, or plant growth chamber.

The agrochemicals and metabolic inhibitors of the present invention may be applied in combination with other agrochemically active substances, such as other herbicides, fungicides, or insecticides. Applying several herbicides with distinct mechanisms of action may be useful, for example, for treating fields with herbicide-resistant weeds such as barnyardgrass. The herbicide treatments may also be applied in combination with safeners, fertilizers and/or growth regulators, for example in the form of a ready mix or a tank mix.

Unless otherwise specified or indicated by context, the terms “a”, “an”, and “the” mean “one or more.” For example, “a molecule” should be interpreted to mean “one or more molecules.”

As used herein, “about”, “approximately,” “substantially,” and “significantly” will be understood by persons of ordinary skill in the art and will vary to some extent on the context in which they are used. If there are uses of the term which are not clear to persons of ordinary skill in the art given the context in which it is used, “about” and “approximately” will mean plus or minus ≤10% of the particular term and “substantially” and “significantly” will mean plus or minus >10% of the particular term.

As used herein, the terms “include” and “including” have the same meaning as the terms “comprise” and “comprising.” The terms “comprise” and “comprising” should be interpreted as being “open” transitional terms that permit the inclusion of additional components further to those components recited in the claims. The terms “consist” and “consisting of” should be interpreted as being “closed” transitional terms that do not permit the inclusion additional components other than the components recited in the claims. The term “consisting essentially of” should be interpreted to be partially closed and allowing the inclusion only of additional components that do not fundamentally alter the nature of the claimed subject matter.

All methods described herein can be performed in any suitable order unless otherwise indicated herein or otherwise clearly contradicted by context. The use of any and all examples, or exemplary language (e.g., “such as”) provided herein, is intended merely to better illuminate the invention and does not pose a limitation on the scope of the invention unless otherwise claimed. No language in the specification should be construed as indicating any non-claimed element as essential to the practice of the invention.

All references, including publications, patent applications, and patents, cited herein are hereby incorporated by reference to the same extent as if each reference were individually and specifically indicated to be incorporated by reference and were set forth in its entirety herein.

Preferred aspects of this invention are described herein, including the best mode known to the inventors for carrying out the invention. Variations of those preferred aspects may become apparent to those of ordinary skill in the art upon reading the foregoing description. The inventors expect a person having ordinary skill in the art to employ such variations as appropriate, and the inventors intend for the invention to be practiced otherwise than as specifically described herein.

Accordingly, this invention includes all modifications and equivalents of the subject matter recited in the claims appended hereto as permitted by applicable law. Moreover, any combination of the above-described elements in all possible variations thereof is encompassed by the invention unless otherwise indicated herein or otherwise clearly contradicted by context.

### EXAMPLES

### Example 1

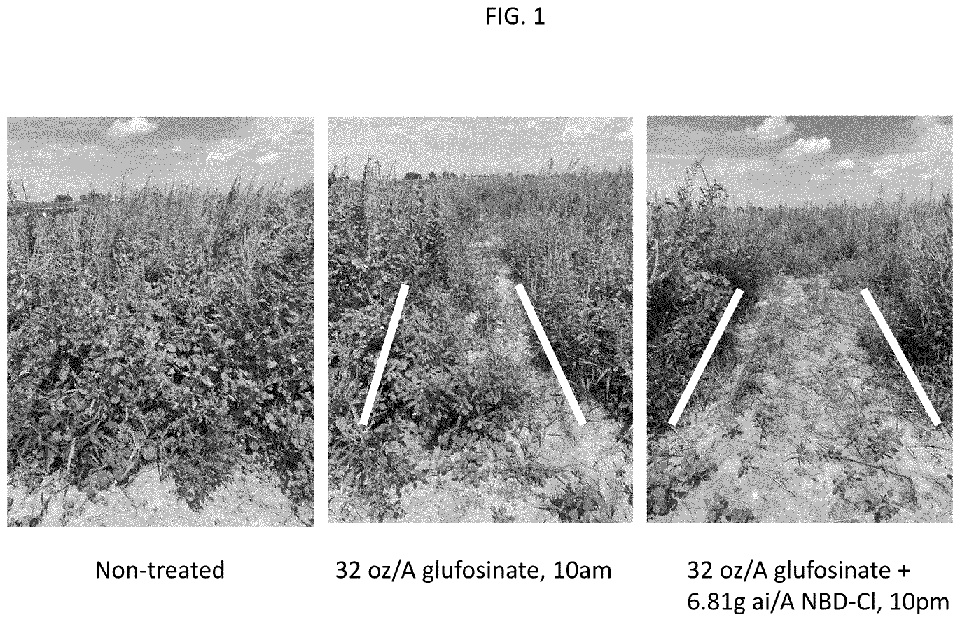

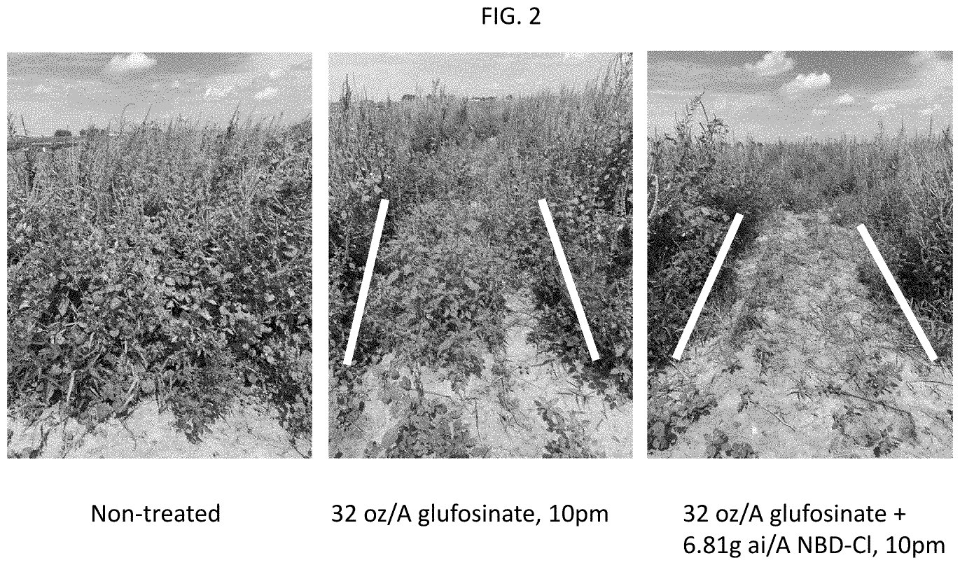

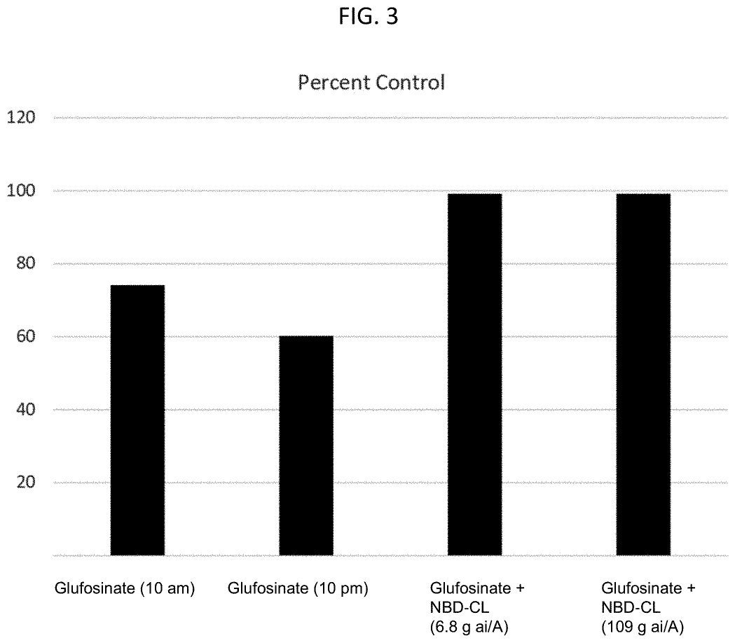

A field experiment was conducted in August in Fayetteville, Ark., to evaluate the addition of a broad-spectrum metabolic inhibitor to glufosinate when applied at night. A “glufosinate alone” treatment was applied at 10 am and 10 pm at 236 g ai A⁻¹, to allow for comparison to a standard commercial application and comparison to an application with reduced activity due to a lack of light intensity, respectively (FIG. 1, FIG. 2). A metabolic inhibitor, 4-chloro-7-nitrobenzofurazan (NBD-CL), was mixed with glufosinate at two rates (6.8 g ai A-1 and 109 g ai A-1) and was applied at 10 pm under dark conditions. The combination treatment (i.e., glufosinate+NBD-CL) provided 99% control of 40-inch tall Palmer amaranth when applied at 10 pm at both tested rates (FIG. 3; Table 1). In contrast, when glufosinate alone was applied at 10 am and 10 pm, only 74% and 60% of Palmer amaranth control was achieved, respectively. Thus, the addition of a metabolic inhibitor to glufosinate eliminates variability in its efficacy due to light intensity. According to the label for glufosinate alone (i.e., when not using with any metabolic inhibitor), Palmer amaranth should be less than 4 inches tall when it is treated with glufosinate for effective control. Thus, the addition of this inhibitor allowed glufosinate to control larger than labeled Palmer amaranth.

TABLE 1
Palmer amaranth control

| | Rate | | Palmer amaranth |
|---|---|---|---|
| Treatment | (g ai A⁻¹) | Time | control (%)* |
| Glufosinate | 236 | 10 am | 74b |
| Glufosinate | 236 | 10 pm | 60c |
| Glufosinate + NBD-CL | 236 + 6.8 | 10 pm | 99a |
| Glufosinate + NBD-CL | 236 + 109 | 10 pm | 99a |

*The different letters following these values indicate that they are statistically different based on a Fisher's protected least significant difference (LSD) test with an alpha value of 0.05.

### Example 2

A greenhouse experiment was conducted in March in which flavonoid GST blockers were added to an L-glufosinate ammonium salt, i.e., KFD-581-01, to evaluate their effect on the efficacy of glufosinate. The tested flavonoid GST blockers included: curcumin, baicalin, ellagic acid, quercetin, and caffeic acid.

The specific treatments listed in Table 2 were applied to a field infested with a Palmer amaranth (Amaranthus palmi) weed pest. The treatments were applied 38 days after planting at an application volume of 150 L/ha. At application, the weed typically possessed 6-8 leaves and was 8-12 cm tall. The treatments were applied with a DeVries Precision spray booth sprayer using a TeeJet 8002 nozzle.

TABLE 2
Treatments

| | |
|---|---|
| 1. | Untreated check |
| 2. | KFD-580-01 @ 300 g ai/ha |
| 3. | KFD-580-01 @ 300 g ai/ha + NBD-CL @ 17 g ai/ha |
| 4. | KFD-580-01 @ 300 g ai/ha + NBD-CL @ 34 g ai/ha |
| 5. | KFD-580-01 @ 300 g ai/ha + NBD-CL @ 67 g ai/ha |
| 6. | KFD-580-01 @ 300 g ai/ha + Curcumin @ 17 g ai/ha |
| 7. | KFD-580-01 @ 300 g ai/ha + Curcumin @ 34 g ai/ha |
| 8. | KFD-580-01 @ 300 g ai/ha + Curcumin @ 67 g ai/ha |
| 9. | KFD-580-01 @ 300 g ai/ha + Baicalin @ 17 g ai/ha |
| 10. | KFD-580-01 @ 300 g ai/ha + Baicalin @ 34 g ai/ha |
| 11. | KFD-580-01 @ 300 g ai/ha + Baicalin @ 67 g ai/ha |
| 12. | KFD-580-01 @ 300 g ai/ha + Ellagic Acid @ 17 g ai/ha |
| 13. | KFD-580-01 @ 300 g ai/ha + Ellagic Acid @ 34 g ai/ha |
| 14. | KFD-580-01 @ 300 g ai/ha + Ellagic Acid @ 67 g ai/ha |
| 15. | KFD-580-01 @ 300 g ai/ha + Quercetin @ 17 g ai/ha |
| 16. | KFD-580-01 @ 300 g ai/ha + Quercetin @ 34 g ai/ha |
| 17. | KFD-580-01 @ 300 g ai/ha + Quercetin @ 67 g ai/ha |
| 18. | KFD-580-01 @ 300 g ai/ha + Caffeic Acid @ 17 g ai/ha |
| 19. | KFD-580-01 @ 300 g ai/ha + Quercetin @ 34 g ai/ha |
| 20. | KFD-580-01 @ 300 g ai/ha + Quercetin @ 67 g ai/ha |

### Results:

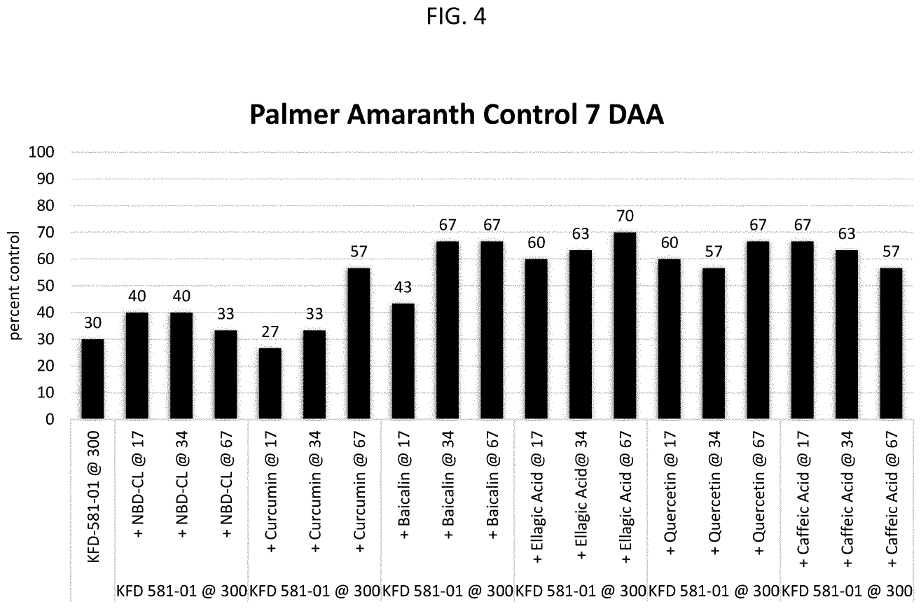

At 7 days after application (DAA) all GST blocker additives, except for the 17 g ai/ha rate of curcumin, increased the level of control of Palmer amaranth above that provided by KFD-581-01 alone (FIG. 4). The most effective treatments were the two highest rates of baicalin and all rates of ellagic acid, quercetin, and caffeic acid (FIG. 4).

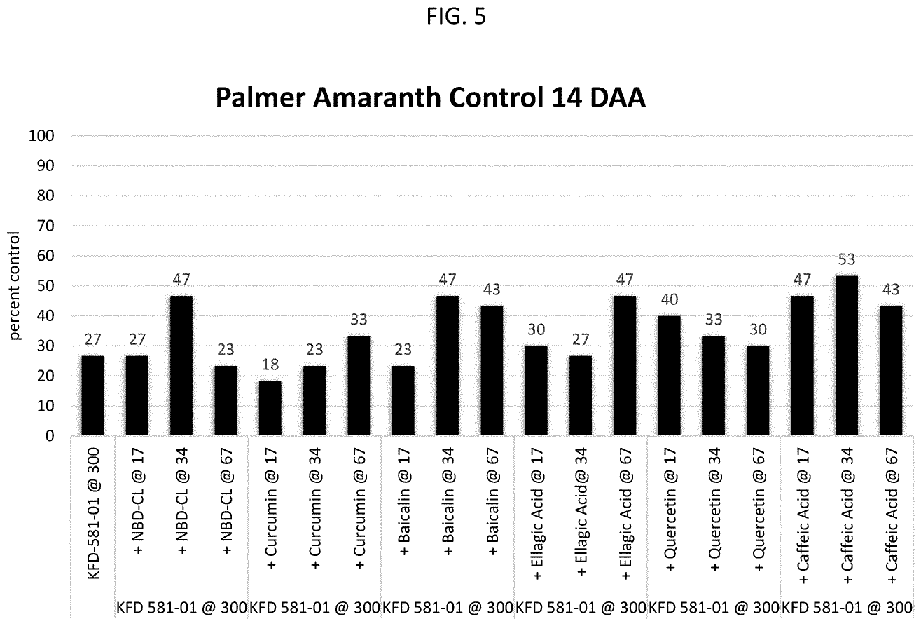

By 14 DAA, Palmer amaranth control had declined for all treatments (FIG. 5). This was likely because the application was made 10-14 days later than a typical field application to make the Palmer amaranth more difficult to control. As a result, we observed a lower level of initial control and a higher level of regrowth for all treatments. Even under these less than ideal conditions, the higher rates of baicalin, ellagic acid, and caffeic acid increased levels of Palmer amaranth control compared to KFD-581-01 applied alone at 14 DAA (FIG. 5).

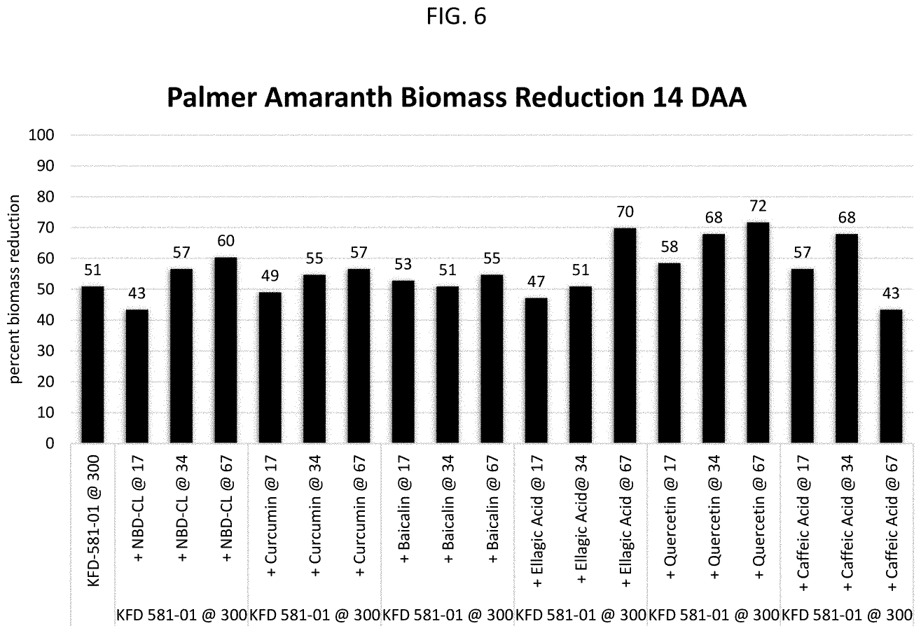

Reduction in above-ground biomass compared to the untreated check was measured at 14 DAA (FIG. 6). The results of this assessment were consistent with the visual assessments described above, i.e., the treatments that appeared to be more effective resulted in higher biomass reductions. The higher rates of ellagic acid and quercetin produced the largest reductions in biomass (FIG. 6).

### Conclusions:

When applied to Palmer amaranth at an advanced growth stage, the addition of baicalin, ellagic acid, quercetin, or caffeic acid to KFD-581-01 improved the visual efficacy and percent biomass reduction as compared to KFD-581-01 alone.

The clearest differences between the compounds occurred at 7 DAA. At 7 DAA, the two higher rates of baicalin, and all rates of ellagic acid, quercetin, and caffeic acid were more effective than any rate of curcumin or NBD-CL. Efficacy was greatest at the highest rate (i.e., 67 g ai/ha) for all compounds, except for NBD-CL and caffeic acid, which showed decreased efficacy at the highest rate compared to the low or mid rates.

What is claimed:

1. A combination comprising an agrochemical and a metabolic inhibitor.

2. The combination of claim 1, wherein the agrochemical is glufosinate, an isomer thereof, a salt thereof, or an ester thereof.

3. The combination of claim 1, wherein the agrochemical is L-glufosinate or a monosodium salt, disodium salt, monopotassium salt, dipotassium salt, calcium salt, ammonium salt, NH₃(CH₃)⁺, NH₂(CH₃)₂⁺, NH(CH₃)₃⁺, NH(CH₃)₂(C₂H₄OH)⁺, or NH₂(CH₃)(C₂H₄OH)⁺ salt thereof.

4. The combination of claim 1, wherein the metabolic inhibitor comprises a polyphenol.

5. The combination of claim 4, wherein the polyphenol is ellagic acid, curcumin, quercetin, baicalin, caffeic acid, or any combination thereof.

6. The combination of claim 1, wherein the metabolic inhibitor inhibits a glutathione-S-transferase enzyme, the glyoxylate pathway, or a cytochrome P450 enzyme.

7. The combination of claim 6, wherein the metabolic inhibitor comprises 4-chloro-7-nitrobenzofurazan (NBD-CL).

8. The combination of claim 1, further comprising an adjuvant.

9. The combination of claim 8, wherein the adjuvant is a surfactant or crop oil.

10. A method of improving the efficacy of an agrochemical, said method comprising using the agrochemical in the presence of a metabolic inhibitor.

11. The method of claim 10, wherein the agrochemical is glufosinate, an isomer thereof, a salt thereof, or an ester thereof.

12. The method of claim 10, wherein the agrochemical is L-glufosinate or a monosodium salt, disodium salt, monopotassium salt, dipotassium salt, calcium salt, ammonium salt, NH₃(CH₃)⁺, NH₂(CH₃)₂⁺, NH(CH₃)₃⁺, NH(CH₃)₂(C₂H₄OH)⁺, or NH₂(CH₃)(C₂H₄OH)⁺ salt thereof.

13. The method of claim 10, wherein the metabolic inhibitor comprises a polyphenol.

14. The method of claim 13, wherein the polyphenol is ellagic acid, curcumin, tannic acid, quercetin, baicalin, caffeic acid, cinnamic acid, or any combination thereof.

15. The method of claim 10, wherein the metabolic inhibitor inhibits a glutathione-S-transferase enzyme, the glyoxylate pathway, or a cytochrome P450 enzyme.

16. The method of claim 15, wherein the metabolic inhibitor comprises 4-chloro-7-nitrobenzofurazan (NBD-CL).

17. A method for controlling grasses or broadleaf weeds, said method comprising applying an agrochemical and a metabolic inhibitor to a field having the grasses or weeds.

18. The method of claim 17, wherein the agrochemical is glufosinate, an isomer thereof, a salt thereof, or an ester thereof.

19. The method of claim 17, wherein the agrochemical is L-glufosinate or a monosodium salt, disodium salt, monopotassium salt, dipotassium salt, calcium salt, ammonium salt, NH₃(CH₃)⁺, NH₂(CH₃)₂⁺, NH(CH₃)₃⁺, NH(CH₃)₂(C₂H₄OH)⁺, or NH₂(CH₃)(C₂H₄OH)⁺ salt thereof.

20. The method of claim 17, wherein the metabolic inhibitor comprises a polyphenol.

21. The method of claim 20, wherein the polyphenol is ellagic acid, curcumin, tannic acid, quercetin, baicalin, caffeic acid, cinnamic acid, or any combination thereof.

22. The method of claim 17, wherein the metabolic inhibitor inhibits a glutathione-S-transferase enzyme, the glyoxylate pathway, or a cytochrome P450 enzyme.

23. The method of claim 22, wherein the metabolic inhibitor comprises 4-chloro-7-nitrobenzofurazan (NBD-CL).

24. The method of claim 17, wherein the field has a crop therein.

25. The method of claim 24, wherein the crop is genetically engineered to be resistant to the agrochemical.
